(19) United States
(12) Patent Application Publication
(10) Pub. No.: US 2015/0254750 A1
(43) Pub. Date: Sep. 10, 2015

(54) PERFORMING COMMERCE QUERIES USING A COMMERCE GRAPH

(71) Applicant: INTUIT INC., Mountain View, CA (US)

(72) Inventors: George Roumeliotis, Menlo Park, CA (US); Brian Wilt, Mountain View, CA (US); Heather Wasserlein, Palo Alto, CA (US)

(73) Assignee: INTUIT INC., Mountain View, CA (US)

(21) Appl. No.: 14/198,364

(22) Filed: Mar. 5, 2014

(51) Int. Cl. G06Q 30/06; G06F 17/30

(52) U.S. Cl. CPC G06Q 30/0625; G06F 17/3053

(57) ABSTRACT

During a search technique, results for a commerce query associated with a desired financial transaction are determined using information in a data structure that specifies a commerce graph. This commerce graph may include nodes and branches indicating financial interrelationships among a set of entities (such as individuals or businesses), and the financial interrelationships may include: inputs to the set of entities, outputs from the set of entities, and previous financial transactions among the set of entities.

### BACKGROUND

The present disclosure relates to a technique for performing a commerce query associated with a desired financial transaction. More specifically, the present disclosure relates to a technique for performing a commerce-query associated with a desired financial transaction using the financial interrelationships among entities specified in a commerce graph.

Search engines are increasingly popular tools for accessing disparate sources of information. When using a search engine, a user typically provides a search query. The search engine may compare a search expression (which is based on the search query, and includes synonyms and permutations of terms in the search query) to a corpus of documents (such as websites and web pages on the Internet) to determine match scores for the documents, which provide metrics of the relevance of the documents. For example, the match score for a document may be based on its content. In particular, the match score may be based on the occurrence of terms in the search expression in the document. In addition, the match score may be based on other factors, such as: the popularity of the document (such as the number of other documents linking or referring to the document) and the popularity of the referring documents. Next, the search engine may rank the documents based on the match scores, and a subset of one or more documents with the highest match scores may be presented as an ordered list of search results to the user.

Ideally, the search results include documents that are relevant (i.e., useful) to the user. In practice, the effectiveness of the search engine is often dependent on the specific search query. For example, many search engines provide relevant results for common queries that involve many users and/or many documents (i.e., in effect, these search engines leverage the ‘knowledge of crowds’ to find potential results). However, the quality of the search results is often degraded for less-common or specialized queries (such as those for which there are too few referring documents, so that it is difficult to determine the popularity of any given document), which is frustrating for users.

### SUMMARY

The disclosed embodiments relate to a computer system that performs a commerce query. During operation, the computer system receives a commerce query associated with a desired financial transaction. Moreover, the computer system generates a commerce-query expression based on the commerce query, where the commerce-query expression includes synonyms associated with the commerce query. Then, the computer system determines match scores between the commerce-query expression and entries in a data structure that includes historical financial data for a set of entities, where the data structure represents a commerce graph with nodes and branches indicating financial interrelationships among the set of entities, and the financial interrelationships include inputs to the set of entities, outputs from the set of entities, and previous financial transactions among the set of entities. Next, the computer system provides a set of results for the commerce query based on the determined match scores.

Note that the determined match scores may be based on context information associated with the commerce query. Moreover, the context information may specify a location where the commerce query originated. Alternatively or additionally, the context information may include: a timestamp when the commerce query was received; and/or previous commerce queries that were received. Note that the previous commerce queries and the commerce query may have been received from a user. In some embodiments, the context information includes a user profile.

Furthermore, the match scores may be based on attributes associated with the set of entities.

Additionally, the financial transactions may have been conducted using financial vehicles associated with different financial institutions.

Another embodiment provides a method that includes at least some of the operations performed by the computer system.

Another embodiment provides a computer-program product for use with the computer system. This computer-program product includes instructions for at least some of the operations performed by the computer system.

### BRIEF DESCRIPTION OF THE FIGURES

FIG. 1 is a flow chart illustrating a method for performing a commerce query in accordance with an embodiment of the present disclosure.

FIG. 2 is a flow chart illustrating the method of FIG. 1 in accordance with an embodiment of the present disclosure.

FIG. 3 is a drawing illustrating a commerce graph in accordance with an embodiment of the present disclosure.

FIG. 4 is a block diagram illustrating a system that performs the method of FIGS. 1 and 2 in accordance with an embodiment of the present disclosure.

FIG. 5 is a block diagram illustrating a computer system that performs the method of FIGS. 1 and 2 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a computer system, a technique for performing a commerce query, and a computer-program product (e.g., software) for use with the computer system are described. During this search technique, results for a commerce query associated with a desired financial transaction are determined using information in a data structure that specifies a commerce graph. This commerce graph may include nodes and branches indicating financial interrelationships among a set of entities (such as individuals or businesses), and the financial interrelationships may include: inputs to the set of entities, outputs from the set of entities, previous financial transactions among the set of entities, and information about the entities.

By using the financial-relationship information to modify the order of the results, the search technique may be able to provide more relevant results to a user. In particular, the interrelationships among the set of entities (which are represented by the commerce graph) may specify a relationship between the user and potential results, thereby allowing the user's interests to be accurately determined at the time they provide a commerce query. For example, the user's interests and relevant entities may be specified by their previous purchasing decisions (and, more generally, financial transactions). This may allow more relevant results to be determined for the user, even when performing searches involving small sets of entities (i.e., the types of searches where the behavior of a larger number of entities cannot be used, and thus where traditional search engines have difficulty in obtaining accurate results). Therefore, the search technique may allow the user to make better decisions when conducting the desired financial transaction, which can increase customer satisfaction and, thus, may increase the revenue of a provider of the search technique.

In the discussion that follows, a user may include: an individual or a person (for example, an existing customer, a new customer, a service provider, a vendor, a contractor, etc.), an organization, a business and/or a government agency. Furthermore, a ‘business’ should be understood to include: for-profit corporations, non-profit corporations, organizations, groups of individuals, sole proprietorships, government agencies, partnerships, etc.

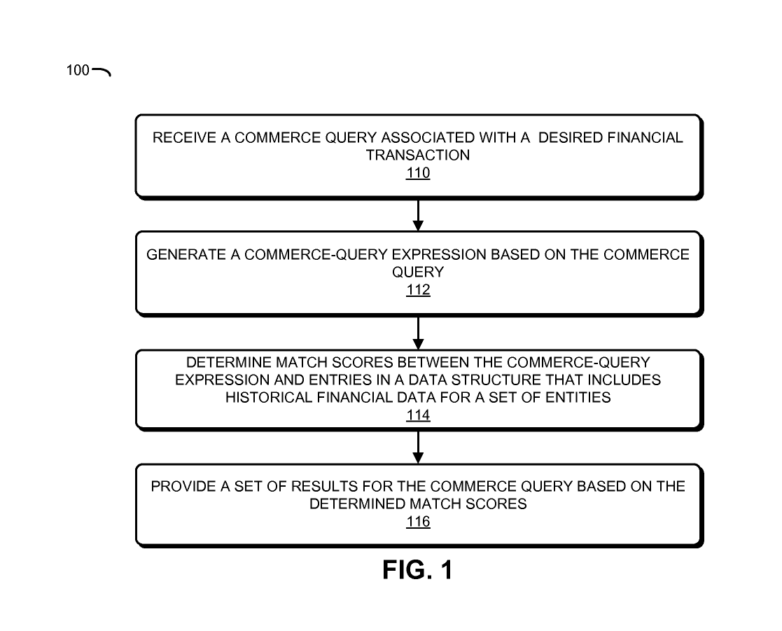

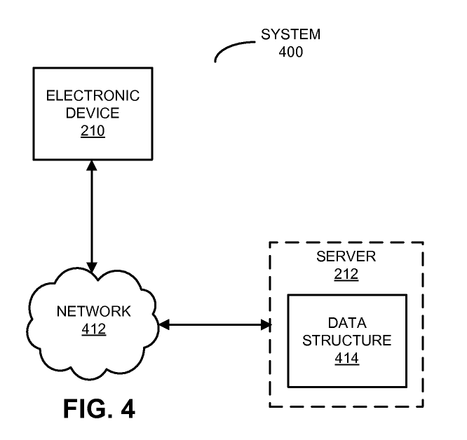

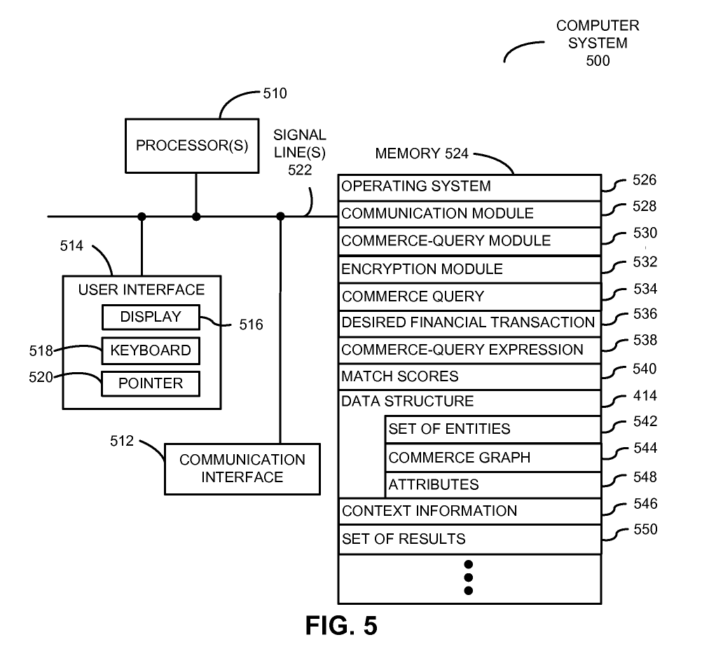

We now describe embodiments of the search technique. FIG. 1 presents a flow chart illustrating a method 100 for performing a commerce query, which may be performed by a computer system (such as computer system 500 in FIG. 5). During operation, the computer system receives a commerce query associated with a desired financial transaction (operation 110). For example, the computer system may receive a commerce query related to a type of business when a user wants to purchase a particular item or service. As described further below with reference to FIG. 4, the commerce query may be received from the user or from an application (such as a software application) being used by the user. In the discussion that follows, a ‘commerce query’ should be understood to include a type of search query used when a user of the computer system is looking for information related to a financial transaction. Thus, a commerce query may include searches for information that, directly or indirectly, specifies: a potential counterparty in the financial transaction; a third party that can facilitate the financial transaction (such as a provider of a financial service or a financial vehicle); a supplier of a product or service; the product or service; and/or content that helps facilitate the financial transaction. The search results in response to the commerce query facilitate the financial transaction or decision making about the financial transaction.

Moreover, the computer system generates a commerce-query expression based on the commerce query (operation 112), where the commerce-query expression includes synonyms associated with the commerce query. In particular, the commerce-query expression may include synonyms for words or phrases in the commerce query (and, more generally, terms in the commerce query), as well as permutations on the ordering of the words or phrases. In addition, common terms (such as articles) may be removed, or may have weights in the commerce-query expression that are inversely related to a frequency of such terms and a corpus of documents (such as the commerce graph, which is described further below). For example, the commerce query ‘the fast car’ may be converted into the commerce-query expression ‘fast car, sports car, fast automobile, sporty automobile, . . . ’, etc. In this way, the commerce-query expression may represent a generalized version of the commerce query, which may increase the likelihood that the results obtained in response to the commerce query are relevant to the user.

Then, the computer system determines match scores between the commerce-query expression and entries in a data structure (the corpus of documents) that includes historical financial data for a set of entities (operation 114). For example, the match score for a given entry in the data structure may be a weighted summation of occurrences of terms in the commerce-query expression in the given entry, where the weights are based both on the occurrences of the terms and their context (such as the distance between the occurrences of the terms).

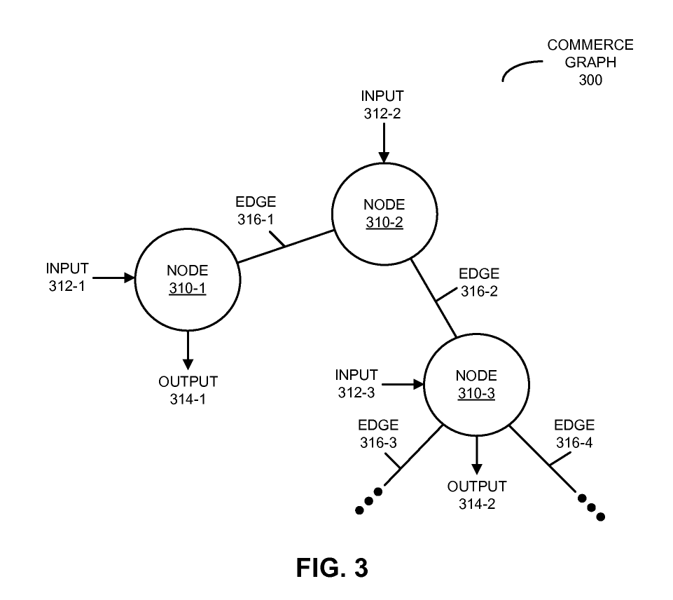

Thus, the match score may be determined using the occurrences of terms in the commerce-query expression in a given entry in the data structure, such as a financial transaction in the user's (or a group of users′) financial-transaction history. This financial-transaction history may include financial information about the user or the group of users that was obtained from multiple different entities (such as different banks, different financial institutions, separate providers of different debit or credit cards, etc.). As described further below with reference to FIG. 3, the data structure may represent a commerce graph with nodes and branches indicating financial interrelationships among the set of entities (such as individuals, groups of individuals, companies, organizations, etc.), and the financial interrelationships include inputs to the set of entities, outputs from the set of entities, and previous financial transactions among the set of entities.

Note that the determined match scores may also be based on context information associated with the commerce query, such as: a location of the user's electronic device where the commerce query originated, a timestamp when the commerce query was received (e.g., the desired financial transaction may be more likely to be related to a restaurant or food at mealtimes), a day the commerce query was received, and/or previous commerce queries that were received. This context information may be included in the match score using additional or modified terms and/or weights in a weighted summation. Moreover, the previous commerce queries and the commerce query may have been received from the user. In some embodiments, the context information includes a user profile of the user (thus, interests of the user, the user's education level or the user's profession may be used to refine the match scores and/or the results for the commerce query).

Furthermore, the match scores may be based on attributes associated with the set of entities in the data structure. For example, the attributes may include: names, aliases, customer loyalty, customer rankings of the set of entities, customer feedback about the set of entities (such as information about quality or satisfaction), one or more locations associated with the set of entities (such as locations of retail establishments or street addresses), sales volumes and/or return rates. Note that the use of the context information and/or the attributes may improve the relevance of the results to the user.

Additionally, the financial transactions may have been conducted using financial vehicles associated with different financial institutions, such as different types of credit cards or debit cards provided by different banks or providers.

Furthermore, the computer system provides a set of results for the commerce query based on the determined match scores (operation 116). For example, the computer system may provide information about one or more entities (such as an ordered list of the one or more entities) to the user's electronic device.

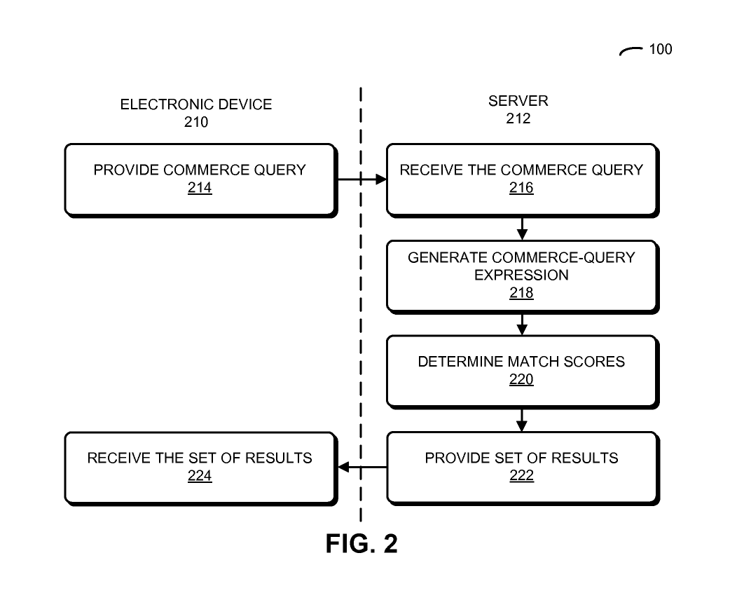

In an exemplary embodiment, the search technique is implemented using an electronic device (such as a computer or a portable electronic device, e.g., a cellular telephone) and a computer, which communicate through a network, such as a cellular-telephone network and/or the Internet (e.g., using a client-server architecture). This is illustrated in FIG. 2, which presents a flow chart illustrating method 100 (FIG. 1).

During the method, electronic device 210 provides (operation 214) and server 212 receives (operation 216) the commerce query associated with the desired financial transaction. Then, server 212 generates the commerce-query expression (operation 218) based on the commerce query.

Moreover, server 212 determines match scores (operation 220) between the commerce-query expression and the entries in the data structure that includes the historical financial data for the set of entities. As noted previously, a match score for a given entry in the data structure may be determined as the weighted summation of matches of terms in the commerce-query expression in the given entry, where the weights specify the relative importance of the terms (based on factors such as the inverse document frequency, context, etc.). Alternatively, a weighted-product model and, more generally, a decision-making technique may be used to determine the match scores. In some embodiments, attributes associated with the set of entities are used to modify weights that determine the match scores and/or may be included as additional terms in the weighted summations.

Next, server 212 provides (operation 222) and electronic device 210 receives (operation 224) the set of results for the commerce query based on the determined match scores.

In some embodiments of method 100 (FIGS. 1 and 2), there may be additional or fewer operations. Moreover, the order of the operations may be changed, and/or two or more operations may be combined into a single operation.

In an exemplary embodiment, the search technique is used to provide business search results using a commerce graph, context information and/or business metrics or attributes (such as: business volume, customer loyalty, business location, etc.). This search technique may allow information about historical financial data (including the financial interrelationships among the set of entities) in the commerce graph to be efficiently and accurately accessed. Indeed, the search technique may be similarly enabling for a wide variety of applications that want to leverage the knowledge embodied in the commerce graph. For example, an application may search or query information in the commerce graph in response to the desired financial transaction.

The commerce graph may represent the interrelationships (and, in particular, the financial interrelationships) among a set of entities (such as individuals, organizations, businesses, companies, commercial entities, etc.). These entities may have financial interactions or transactions in a business ‘ecosystem.’ Note that such an ecosystem may range from a local region to a country (or the world), or may include an industry. In some embodiments, the ecosystem encompasses the financial transactions that occur among a set of entities that utilize a group of financial applications provided by one or more providers, such as: income-tax software, accounting software, payroll software, online banking, mobile-payment applications, etc. Moreover, the group of financial applications may be executed on a variety of platforms, such as: portable electronic devices, desktop computers, etc. As such, the financial transactions may be performed or conducted using financial instruments provided by multiple different financial institutions. For example, individuals in the ecosystem may purchase goods and services from one another using different types of credit cards, debit cards and/or checks that are supported by different banks, at least some of which are outside of each other's financial networks or financial-management systems.

Therefore, the commerce graph may include information about financial interrelationships that is more comprehensive than that available within a given financial network (such as a credit-card network) supported by a particular group of financial institutions (stated differently, the commerce graph may integrate previously siloed information from different financial networks or financial-management systems). This ‘360° financial perspective’ in the commerce graph may provide more complete and accurate information about the financial interrelationships and transactions among the set of entities. Furthermore, this capability may facilitate more accurate results in response to commerce queries, which in turn may allow users to conduct desired financial transactions and to obtain more favorable outcomes (e.g., it may improve consumer satisfaction with the financial transactions).

In addition, the financial interrelationships embodied in the commerce graph may allow multiple financial accounts of an individual to be identified. For example, because of data-entry errors (such as typographical errors), there may be differences in the personal or user information of an individual in two different financial accounts (one for income-tax software and the other for accounting software). The wealth of information in the commerce graph may be used to determine that these two financial accounts correspond to the same individual. Thus, the commerce graph may cluster information (such as user information: an individual's name, address, phone number, web-page uniform resource locator, etc.) to account for manual-entry errors. More generally, business interrelationships (such as financial accounts, vendor and customer lists, user information, companies, payers, payees, etc.) in historical financial data (such as financial transactions conducted by the set of entities using the group of financial applications in an ecosystem) may be clustered to specify the commerce graph. Note that the financial interrelationships in the commerce graph may include generalized relationships, including: financial transactions, chargebacks, denials, returns, invoices, estimates, contacts in a social network (e.g., professional relationships among individuals), business deals, etc.

FIG. 3 presents a drawing illustrating commerce graph 300. This commerce graph has inputs 312 and outputs 314 from nodes 310 (such as those corresponding to entities), as well as interactions or edges 316 (such as financial transactions) among nodes 310. Note that some outputs from nodes 310 may be included in edges 316. In the context of the search technique, a commerce query may involve or specify one or more: nodes 310, inputs 312, outputs 314, and/or flows between two or more entities 310 (i.e., edges 316). Moreover, the financial interrelationships embodied in commerce graph 300 may allow the relevance of the entities in the set of entities to be ranked in response to a commerce query.

For example, when a consumer, who lives in a particular city, performs a commerce query for a ‘dentist,’ commerce graph 300 may be used to identify dentists. The information about these dentists may be provided based on highly regarded dentists (such as those with more than 75% repeat customers and who have more than 1000 customers) that are within 10 miles of the consumer.

In some embodiments, the results are ordered based on context information, such as when and/or where a commerce query was provided, and/or the results of previous commerce queries (which may indicate the results that are more relevant to the user).

Thus, the results for the commerce query may be determined by explicit matching of the commerce-query expression with the information in the data structure (and, therefore, the information in commerce graph 300) and/or using so-called ‘fuzzy’ or probabilistic matching (which may be based on indirect information, such as attributes and/or context information). Note that the commerce graph 300 may allow different slices of the historical financial data (such as financial transactions among the set of entities over the last six months) to be taken in real time, which may allow useful information for the desired financial transaction to be obtained and presented to the user.

Note that the user may directly perform a commerce query, for example, by providing the commerce query in an entry box or field of a search engine. However, in other embodiments, a commerce query may be performed indirectly. For example, a user may use a software application, which may provide a commerce query in response to the user's desire to conduct a particular financial transaction. Thus, when the user indicates that they want to purchase a particular good or service, the software application may conduct a commerce query to obtain a list of potential vendors with whom the user can conduct this financial transaction. This list of potential vendors may be displayed in a user interface to the user, which may allow the user to select which vendor they want to use.

While the preceding discussion illustrated the search technique being used by an individual or a software application used by the individual, in other embodiments the search technique may be offered as a service to other search-engine providers. For example, if a user of another search engine performs a search query, the provider of this other search engine may interact with commerce graph 300 (e.g., via an application programming interface) to leverage the information embodied in commerce graph 300 to improve the results of the other search engine. Therefore, in some embodiments, the search technique may be used in conjunction with an arbitrary search query conducted using an arbitrary search engine.

We now describe embodiments of a system and the computer system, and their use. FIG. 4 presents a block diagram illustrating a system 400 that can be used, in part, to perform operations in method 100 (FIGS. 1 and 2). In this system, during the search technique a user of electronic device 210 may use a software product, such as a software application that is resident on and that executes on electronic device 210. (Alternatively, the user may interact with a web page that is provided by server 212 via network 412, and which is rendered by a web browser on electronic device 210. For example, at least a portion of the software application may be an application tool that is embedded in the web page, and which executes in a virtual environment of the web browser. Thus, the application tool may be provided to the user via a client-server architecture.) This software application may be a standalone application or a portion of another application that is resident on and which executes on electronic device 210 (such as a software application that is provided by server 212 or that is installed and which executes on electronic device 210).

During the search technique, the user may use the software application to conduct or to research potential vendors for the desired financial transaction. Thus, the user or the software application may provide, via network 412, the commerce query to server 212. In response to receiving the commerce query, server 212 generates the commerce-query expression based on the commerce query.

Then, server 212 determines the match scores between the commerce-query expression and the entries in data structure 414 that includes the historical financial data for the set of entities. Next, server 212 provides, via network 412, the set of results to electronic device 210. Subsequently, electronic device 210 may display at least some of the information in the set of results to the user on a display in electronic device 210. Alternatively or additionally, at least some of the results in the set of results may be used by the software application when conducting the desired financial transactions. For example, the set of results may specify a preferred vendor or supplier in proximity, and the software application may conduct the desired financial transaction (such as purchasing goods or a service) with the preferred vendor or supplier.

Note that information in system 400 may be stored at one or more locations in system 400 (i.e., locally or remotely). Moreover, because this data may be sensitive in nature, it may be encrypted. For example, stored data and/or data communicated via network 412 may be encrypted.

FIG. 5 presents a block diagram illustrating a computer system 500 that performs method 100 (FIGS. 1 and 2), such as server 212 (FIGS. 2 and 4). Computer system 500 includes one or more processing units or processors 510, a communication interface 512, a user interface 514, and one or more signal lines 522 coupling these components together. Note that the one or more processors 510 may support parallel processing and/or multi-threaded operation, the communication interface 512 may have a persistent communication connection, and the one or more signal lines 522 may constitute a communication bus. Moreover, the user interface 514 may include: a display 516, a keyboard 518, and/or a pointer 520, such as a mouse.

Memory 524 in computer system 500 may include volatile memory and/or non-volatile memory. More specifically, memory 524 may include: ROM, RAM, EPROM, EEPROM, flash memory, one or more smart cards, one or more magnetic disc storage devices, and/or one or more optical storage devices. Memory 524 may store an operating system 526 that includes procedures (or a set of instructions) for handling various basic system services for performing hardware-dependent tasks. Memory 524 may also store procedures (or a set of instructions) in a communication module 528. These communication procedures may be used for communicating with one or more computers and/or servers, including computers and/or servers that are remotely located with respect to computer system 500.

Memory 524 may also include multiple program modules (or sets of instructions), including: commerce-query module 530 (or a set of instructions) and/or encryption module 532 (or a set of instructions). Note that one or more of these program modules (or sets of instructions) may constitute a computer-program mechanism.

During the search technique, commerce-query module 530 may receive, via communication interface 512 and communication module 528, a commerce query 534 associated with a desired financial transaction 536. In response to receiving commerce query 534, commerce-query module 530 may generate commerce-query expression 538 based commerce query 534.

Then, commerce-query module 530 determines match scores 540 between commerce-query expression 538 and the entries in data structure 414 that includes the historical financial data for set of entities 542. This data structure may include information specifying commerce graph 544. Note that match scores 540 may be based on context information 546 associated with commerce query 534 and/or attributes 548 associated with set of entities 542.

Next, commerce-query module 530 provides a set of results 550 to the user via communication module 528 and communication interface 512.

Because information used in the search technique may be sensitive in nature, in some embodiments at least some of the data stored in memory 524 and/or at least some of the data communicated using communication module 528 is encrypted or decrypted using encryption module 532.

Instructions in the various modules in memory 524 may be implemented in: a high-level procedural language, an object-oriented programming language, and/or in an assembly or machine language. Note that the programming language may be compiled or interpreted, e.g., configurable or configured, to be executed by the one or more processors 510.

Although computer system 500 is illustrated as having a number of discrete items, FIG. 5 is intended to be a functional description of the various features that may be present in computer system 500 rather than a structural schematic of the embodiments described herein. In some embodiments, some or all of the functionality of computer system 500 may be implemented in one or more application-specific integrated circuits (ASICs) and/or one or more digital signal processors (DSPs).

Computer system 500, as well as electronic devices, computers and servers in system 500, may include one of a variety of devices capable of manipulating computer-readable data or communicating such data between two or more computing systems over a network, including: a personal computer, a laptop computer, a tablet computer, a mainframe computer, a portable electronic device (such as a cellular telephone or PDA), a server, a point-of-sale terminal and/or a client computer (in a client-server architecture). Moreover, network 412 (FIG. 4) may include: the Internet, World Wide Web (WWW), an intranet, a cellular-telephone network, LAN, WAN, MAN, or a combination of networks, or other technology enabling communication between computing systems.

Electronic device 210 (FIGS. 2 and 4), server 212 (FIGS. 2 and 4), system 400 (FIG. 4), and/or computer system 500 may include fewer components or additional components. Moreover, two or more components may be combined into a single component, and/or a position of one or more components may be changed. In some embodiments, the functionality of electronic device 210 (FIGS. 2 and 4), server 212 (FIGS. 2 and 4), system 400 (FIG. 4) and/or computer system 500 may be implemented more in hardware and less in software, or less in hardware and more in software, as is known in the art.

In the preceding description, we refer to ‘some embodiments.’ Note that ‘some embodiments’ describes a subset of all of the possible embodiments, but does not always specify the same subset of embodiments.

While a data structure that includes historical financial data was used as an illustration of the search technique, in other embodiments the search technique may be used with a wide variety of data structures and/or data types, including data structures corresponding to other types of graphs, and data structures that include data other than financial data. Furthermore, while the preceding discussion of the search technique used a commerce query as an illustration, in other embodiments the search technique (and the information embodied in commerce graphs) may be used in conjunction with an arbitrary search query, including a search query other than commerce queries (i.e., queries other than those looking for information associated with a financial transaction). For example, even though a commerce graph is based on financial-transaction histories, the interrelationships embodied in the commerce graph may help identify potential results to a wide variety of queries, including queries other than those associated with business or financial transactions, such as: informational queries (queries that cover a broad topic (e.g., colorado or trucks) for which there may be thousands of relevant results; navigational queries (queries that seek a single website or web page of a single entity (e.g., a company); transactional queries (queries that reflect the intent of the user to perform a particular action, e.g., purchasing a car or downloading a screen saver); and/or connectivity queries (queries that report on the connectivity of an indexed document, e.g., which links point to this document or how many web pages are indexed from a particular document).

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-implemented method for performing a commerce query, the method comprising:
receiving a commerce query associated with a desired financial transaction;
generating a commerce-query expression based on the commerce query, wherein the commerce-query expression includes synonyms associated with the commerce query;
using the computer, determining match scores between the commerce-query expression and entries in a data structure that includes historical financial data for a set of entities, wherein the data structure represents a commerce graph with nodes and branches indicating financial interrelationships among the set of entities, and wherein the financial interrelationships include inputs to the set of entities, outputs from the set of entities, and previous financial transactions among the set of entities; and
providing a set of results for the commerce query based on the determined match scores.

2. The method of claim 1, wherein the determined match scores are based on context information associated with the commerce query.

3. The method of claim 2, wherein the context information specifies a location where the commerce query originated.

4. The method of claim 2, wherein the context information includes a timestamp when the commerce query was received.

5. The method of claim 2, wherein the context information includes previous commerce queries that were received.

6. The method of claim 5, wherein the previous commerce queries and the commerce query were received from a user.

7. The method of claim 2, wherein the context information includes a user profile.

8. The method of claim 1, wherein the match scores are based on attributes associated with the set of entities.

9. The method of claim 1, wherein the financial transactions were conducted using financial vehicles associated with different financial institutions.

10. A computer-program product for use in conjunction with a computer system, the computer-program product comprising a non-transitory computer-readable storage medium and a computer-program mechanism embedded therein to perform a commerce query, the computer-program mechanism including:
instructions for receiving a commerce query associated with a desired financial transaction;
instructions for generating a commerce-query expression based on the commerce query, wherein the commerce-query expression includes synonyms associated with the commerce query;
instructions for determining match scores between the commerce-query expression and entries in a data structure that includes historical financial data for a set of entities, wherein the data structure represents a commerce graph with nodes and branches indicating financial interrelationships among the set of entities, and wherein the financial interrelationships include inputs to the set of entities, outputs from the set of entities, and previous financial transactions among the set of entities; and
instructions for providing a set of results for the commerce query based on the determined match scores.

11. The computer-program product of claim 10, wherein the determined match scores are based on context information associated with the commerce query.

12. The computer-program product of claim 11, wherein the context information specifies a location where the commerce query originated.

13. The computer-program product of claim 11, wherein the context information includes a timestamp when the commerce query was received.

14. The computer-program product of claim 11, wherein the context information includes previous commerce queries that were received.

15. The computer-program product of claim 11, wherein the context information includes a user profile.

16. The computer-program product of claim 10, wherein the match scores are based on attributes associated with the set of entities.

17. The computer-program product of claim 10, wherein the financial transactions were conducted using financial vehicles associated with different financial institutions.

18. A computer system, comprising:
a processor;
memory; and
a program module, wherein the program module is stored in the memory and configurable to be executed by the processor to perform a commerce query, the program module including:
instructions for receiving a commerce query associated with a desired financial transaction;
instructions for generating a commerce-query expression based on the commerce query, wherein the commerce-query expression includes synonyms associated with the commerce query;
instructions for determining match scores between the commerce-query expression and entries in a data structure that includes historical financial data for a set of entities, wherein the data structure represents a commerce graph with nodes and branches indicating financial interrelationships among the set of entities, and wherein the financial interrelationships include inputs to the set of entities, outputs from the set of entities, and previous financial transactions among the set of entities; and
instructions for providing a set of results for the commerce query based on the determined match scores.

19. The computer system of claim 18, wherein the determined match scores are based on context information associated with the commerce query.

20. The computer system of claim 18, wherein the financial transactions were conducted using financial vehicles associated with different financial institutions.
